(19) United States
(12) Patent Application Publication
(10) Pub. No.: US 2019/0126154 A1
(43) Pub. Date: May 2, 2019

(54) SPINNING DEVICE

(71) Applicant: Joshua N. Sears, Milford, OH (US)

(72) Inventor: Joshua N. Sears, Milford, OH (US)

(21) Appl. No.: 16/158,193

(22) Filed: Oct. 11, 2018

Related U.S. Application Data
(60) Provisional application No. 62/579,092, filed on Oct. 30, 2017.

(51) Int. Cl. A63H 1/00

(52) U.S. Cl. CPC A63H 1/00; F16M 13/04

(57) ABSTRACT

A spinnable handheld device. The device can include a handheld device, the handheld device having a flat surface and a center of gravity. A spinner can have a base joined to the flat surface of the handheld device and an external surface extending away from the handheld device, the external surface having an apex. The apex can be disposed at a distance perpendicular to the flat surface near the center of gravity.

### REFERENCE TO RELATED APPLICATION

The present application is a U.S. non-provisional application that claims the priority benefit of U.S. provisional patent application Ser. No. 62/579,092, filed Oct. 30, 2017, and hereby incorporates the same application by reference in its entirety.

### TECHNICAL FIELD

Embodiments of the technology relate, in general, to device permitting free spinning of hand-held devices.

### BACKGROUND

Cellular phones and other handheld devices are ubiquitous. Such devices are often in the hands of users during idle times, including when sitting at a table or counter. Often a user will fidget with his or her device, including attempting to spin it. However, handheld devices have large flat surfaces and are not designed to spin.

Accordingly, there remains an unmet need for a device that can, when used with a handheld device, permit the device to spin.

Further, there remains an unmet need for a device that can facilitate free spinning capability of a handheld device such as a smartphone.

Additionally, there remains an unmet need for a device, system, and method of entertainment for users of handheld devices.

### SUMMARY

A spinnable handheld device is disclosed. The device can include a handheld device, the handheld device having a flat surface and a center of gravity. A spinner can have a base joined to the flat surface of the handheld device and an external surface extending away from the handheld device, the external surface having an apex. The apex can be disposed at a distance perpendicular to the flat surface near the center of gravity.

### BRIEF DESCRIPTION OF THE DRAWINGS

The present disclosure will be more readily understood from a detailed description of some example embodiments taken in conjunction with the following figures:

FIG. 1 depicts a perspective view of a handheld device having joined thereto an embodiment of a spinner of the present disclosure.

FIG. 2 depicts a side view of a handheld device having joined thereto an embodiment of a spinner of the present disclosure.

FIG. 3 depicts a top view of an embodiment of a spinner of the present disclosure.

FIG. 4 depicts a bottom view of an embodiment of a spinner of the present disclosure.

FIG. 5 depicts a side view of an embodiment of a spinner of the present disclosure.

FIG. 6 depicts a perspective view of a handheld device having joined thereto an embodiment of a spinner of the present disclosure.

FIG. 7 depicts a top view of an embodiment of a spinner of the present disclosure.

FIG. 8 depicts a side view of an embodiment of a spinner of the present disclosure.

FIG. 9 depicts a side view of an embodiment of a spinner of the present disclosure.

FIG. 10 depicts a perspective view of a spinner in use on the fingers of a user.

FIG. 11 depicts a side view of an embodiment of a spinner of the present disclosure.

FIG. 12 depicts a side view of an embodiment of a spinner of the present disclosure.

FIG. 13 depicts a side view of an embodiment of a spinner of the present disclosure.

FIG. 14A depicts a screenshot of an app utilized with a spinner of the present disclosure.

FIG. 14B depicts a screenshot of an app utilized with a spinner of the present disclosure.

FIG. 14C depicts a screenshot of an app utilized with a spinner of the present disclosure.

FIG. 14D depicts a screenshot of an app utilized with a spinner of the present disclosure.

FIG. 15A depicts a screenshot of an app utilized with a spinner of the present disclosure.

FIG. 15B depicts a screenshot of an app utilized with a spinner of the present disclosure.

FIG. 15C depicts a screenshot of an app utilized with a spinner of the present disclosure.

FIG. 15D depicts a screenshot of an app utilized with a spinner of the present disclosure.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment”, or “in an embodiment” in places throughout the specification are not necessarily all referring to the same embodiment. Furthermore, the particular features, structures or characteristics may be combined in any suitable manner in one or more embodiments.

Described herein are example embodiments of spinners for use with handheld devices. The spinner converts cell phones, tablets, and other flat-sided items into a fidget spinner style device, and provides the ability to spin the device in top-like fashion. In example embodiments, the handheld device is a smartphone, but the invention need not be so limited. In the illustrated embodiments, a smartphone is shown to describe certain advantages and benefits that can be realized with any handheld device having a relatively flat surface.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

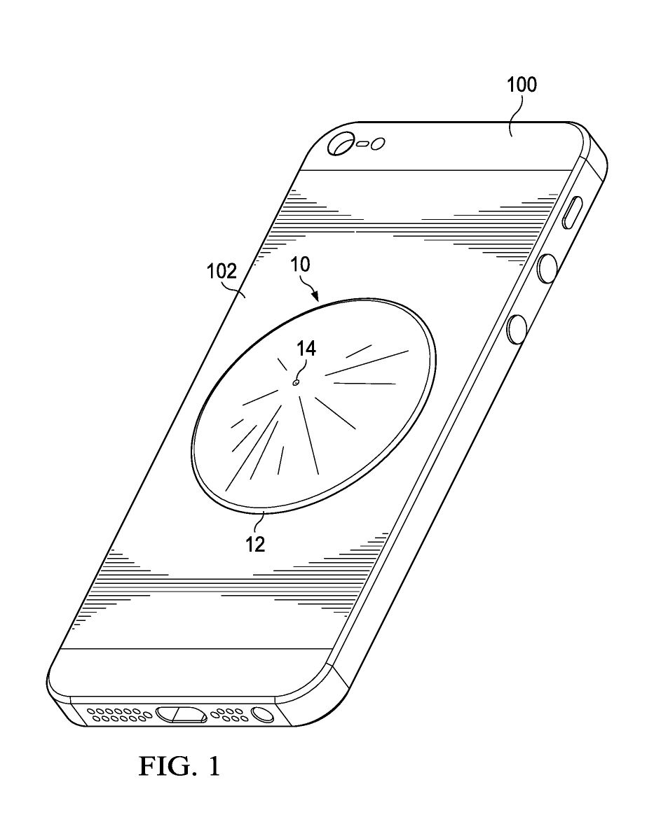

Referring to FIG. 1, there is shown a spinner 10 joined to a smartphone 100. Smartphone can be any of known hand-held devices and can have at least one generally flat surface 102 onto which a spinner 10 can be joined. In an embodiment, it is recognized that flat surface 102 can be the surface of a smartphone case (not shown) without departing from the scope of the present disclosure. The smartphone can have a center of gravity relative to the flat surface 102.

Spinner 10 can be joined by any suitable manner, including by adhesive. Adhesive can be a gel adhesive that permits repeated adherence and removal. In general, spinner 10 can be adhered, removed, and adhered again multiple times, and when adhered can be sufficiently joined as to resist inadvertent removal by use, as described below. Spinner 10 can be made of injection molded plastic, metal, ceramic, wood, or any other material suitable for use as a spinner as described herein.

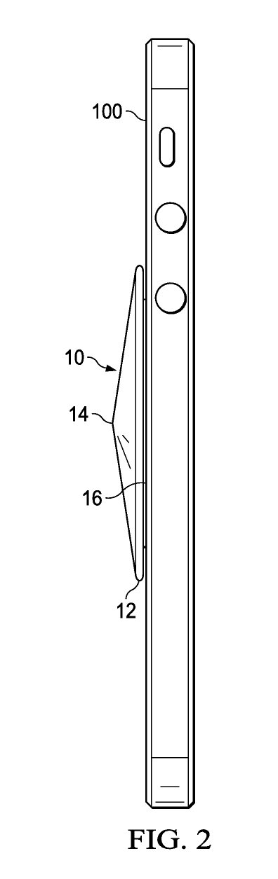

Spinner 10 can have a generally circular shape with an outer perimeter 12 and a raised central apex 14. In operation, spinner 10 can be joined to the flat surface 102 of a smartphone 100 such that the apex 14 is located at or near the smartphone's center of gravity, such that the smartphone can be spun on the apex 14 when the apex 14 is in contact with a horizontal surface such as a table or countertop. By “near” the smartphone's center of gravity is meant that the apex is sufficiently close to the center of gravity in along any coordinate (parallel to or perpendicular to a flat surface of the smartphone) so as to permit balancing of the smartphone on the apex on a surface without the smartphone otherwise touching the surface. As shown in FIG. 2, spinner 10 can have a generally conical shape such that the apex 14 is the tip of the cone. In an embodiment, apex 14 is disposed at a distance perpendicular to the center of gravity, such that the smartphone can be balanced on apex 14 when apex 14 is in gravitational contact with a flat surface.

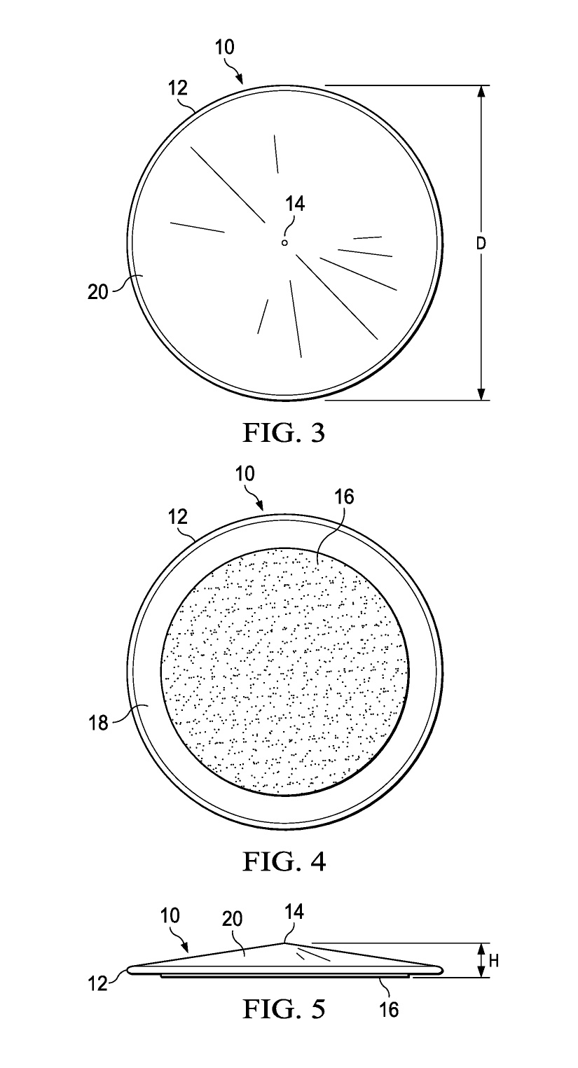

As shown in FIGS. 3-5 showing the top, bottom, and side, respectively, of a representative spinner, spinner 10 can have a flat face 18 on a base 26 opposite the external face 20 and an apex 14. Flat face 18 can include a layer of adhesive 16 thereon for joining to a smartphone. Adhesive layer 16 can be a gel adhesive pad. Adhesive layer 16 can comprise a release paper (not shown) prior to use. Adhesive layer 16 can comprise double-sided tape. Adhesive layer 16 can be supplied separately and added to the flat face 18 prior to joining to a smartphone.

In general, the spinner 10 need not be circular about its perimeter 12, but can be any shape, including square, diamond-shaped, heart-shaped, or in the shape of a logo or trademark. Likewise, the spinner 10 need not be conical, but can be generally flat with a protrusion defining the apex 14. The apex 14 need not be in the center of the spinner 10. That is, apex 14 can protrude from any part of spinner 10 on external side 20, as long as the spinner 10 can be adhered to the smartphone such that the apex 14 is at or near the smartphone's center of gravity.

The size and shape of the spinner 10 can be any size and shape suitable for use on a handheld device. For a smartphone it can be desirable that the spinner 10 not extend past the sides of the smartphone, as depicted in FIG. 1. In general, the largest dimension D across the spinner 10, e.g., the diameter of a circular-shaped spinner, can be from about ½ inch to about 4 inches. In an embodiment, the largest dimension D can be from about 1 to about 3 inches. In an embodiment, the diameter of a circular-shaped spinner 10 can be from about 1½ inches to about 2 inches. The height H of a spinner 10, which can effectively be the distance from the surface of a smartphone 100 to the tip of apex 14, can be from about ⅛ inch to about ½ inch.

To use spinner 10, a user can join spinner 10 to a smartphone, with the apex 14 being at or near the center of gravity of the smartphone. Once joined to the smartphone, the apex 14 of spinner 10 can be placed in contact with a generally flat surface, such as a table top. If the apex is at or near the center of gravity of the smartphone, the smartphone can be balanced on apex 14. A user can then spin the smartphone, and the smartphone will keep spinning like a top on apex 14 for a period of time. If the spinner 10 is not located properly and the smartphone does not spin smoothly, the spinner 10 can be removed and repositioned. Removal and repositioning can continue until the spinner 10 is properly located to permit free spinning on apex 14.

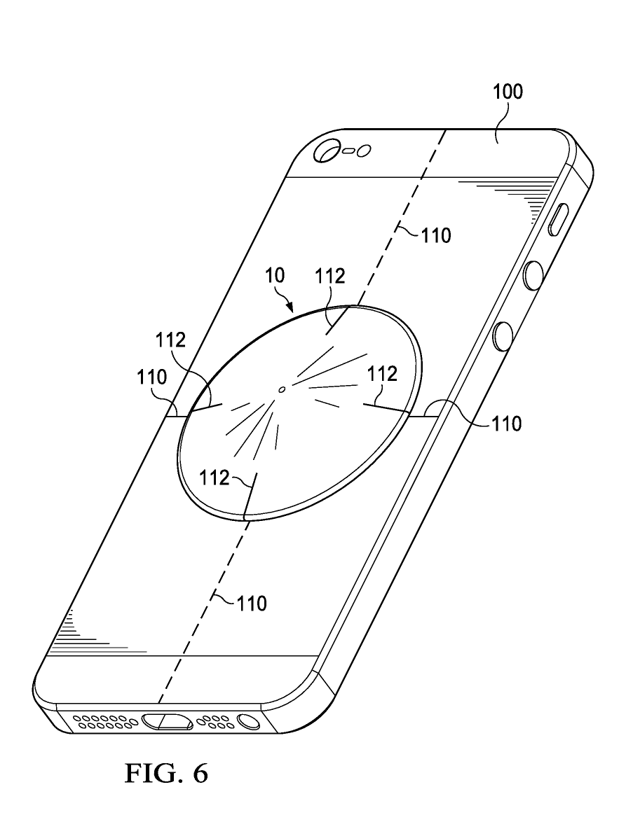

In an embodiment, as shown in FIG. 6, a device such as smartphone 100 can have alignment markings 110 on a face thereof, or on the protective case thereof, that aid in locating the center of gravity of the device. A marking can be a dot, a cross, or, as depicted in FIG. 6, intersecting lines. In an embodiment, the spinner 10 can have corresponding registration lines 112 to aid in aligning the spinner with alignment markings 110 on the smartphone (or smartphone case). In an embodiment, spinner 10 can be transparent or partially transparent to aid in placing the spinner with relation to alignment markings 110, such that apex 14 is aligned with the center of gravity of the smartphone.

In an embodiment, spinner 10 can be built into a smartphone case, such that the spinner is integral with the smartphone case. In an embodiment, a smartphone case has integrated into a flat side thereof a protrusion that is functionally the apex 14. That is, a protrusion extending at least 1/16 inch from a flat surface of a smartphone case can be molded into the case at a location corresponding to the center of gravity of a smartphone in the case. As such, the smartphone could then be spun on the apex 14 like a top on a horizontal surface.

In an embodiment, spinner 10 can have additional features that add functionality, particularly to smaller devices such as a smartphone 100. In an embodiment, external face 20 with apex 14 can be configured to “pop” away from flat face 18 in an accordion fashion in a similar manner as is known for PopSocket Grips. In such an embodiment, external face 20 can be joined to flat face 18 by a flexible membrane that can “flip” between a folded position in which the external face 20 and flat face 18 are in close proximity and the spinner 10 appears substantially as shown in FIG. 1. The flexible membrane can permit the external face 20 to be separated from flat face 18 such that it can “pop” into a position in which it remains separated a distance sufficient for a users fingers to engage the spinner between the external face 20 and flat face 18.

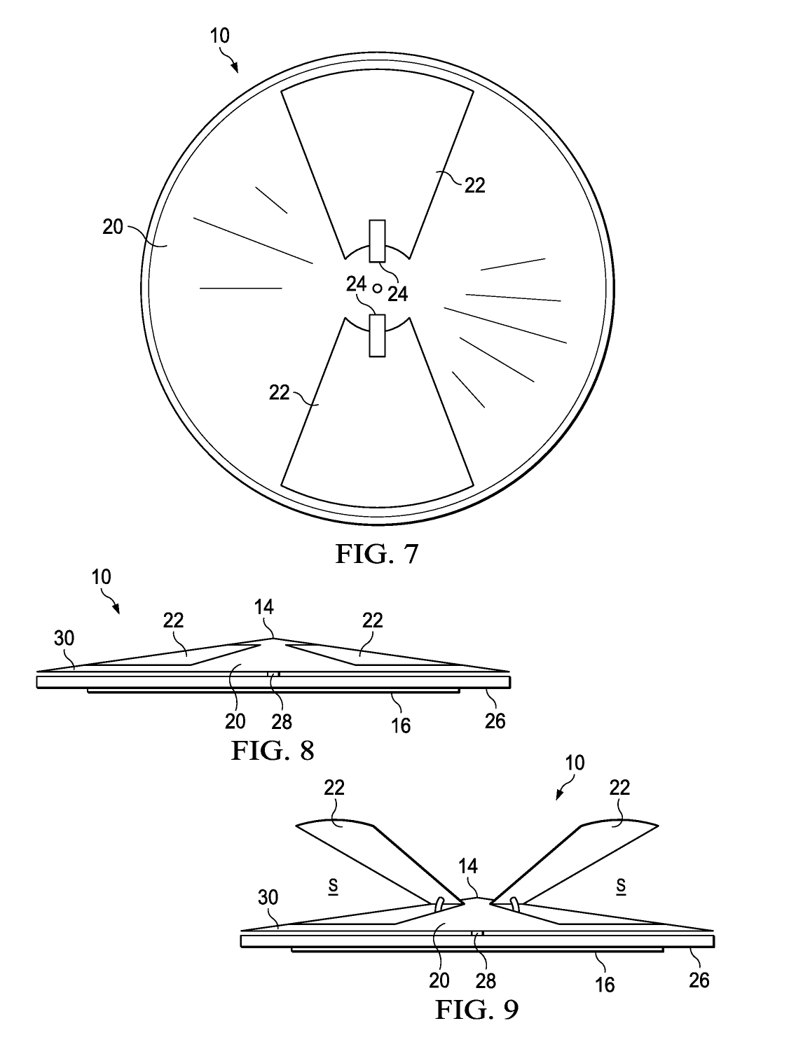

In an embodiment, the functionality of a finger grip can be achieved by including one or more fold- or pop-out tabs. As shown in FIGS. 7-9, spinner 10 can include on the external face 20 one or more hinged tabs 22 connected to the spinner 10 by hinges 24. Hinges 24 can be living hinges. Tabs 22 can be flush with the remaining surface of the external face 20 when in a closed position, as depicted in FIGS. 7 and 8. Tabs 22 can be urged outwardly as illustrated in FIG. 9. When urged into the outward position tabs 22 provide a space S for the fingers of a user to engage the spinner 10. In general, spinner 10 can have one tab 22. Therefore, while the description herein illustrates a two-tab example embodiment, the disclosure is not to be limited to any specific number of tabs 22.

In an embodiment, in addition to the tabs 22 discussed above, the spinner 10 can be configured such that the user can spin the smartphone while holding the spinner between his or her fingers. As shown in FIGS. 8 and 9, for example, spinner 10 can include a pivotally attached base 26 that can be joined to the smartphone, as described above, for example with adhesive 16. Base 26 can be joined to the smartphone 100 such that it is anchored in place. A pivot post 28 can extend from base 26 to rotating portion 30, which can freely rotate about pivot post 28. Pivot post 28 can be axially aligned to intersect apex 14.

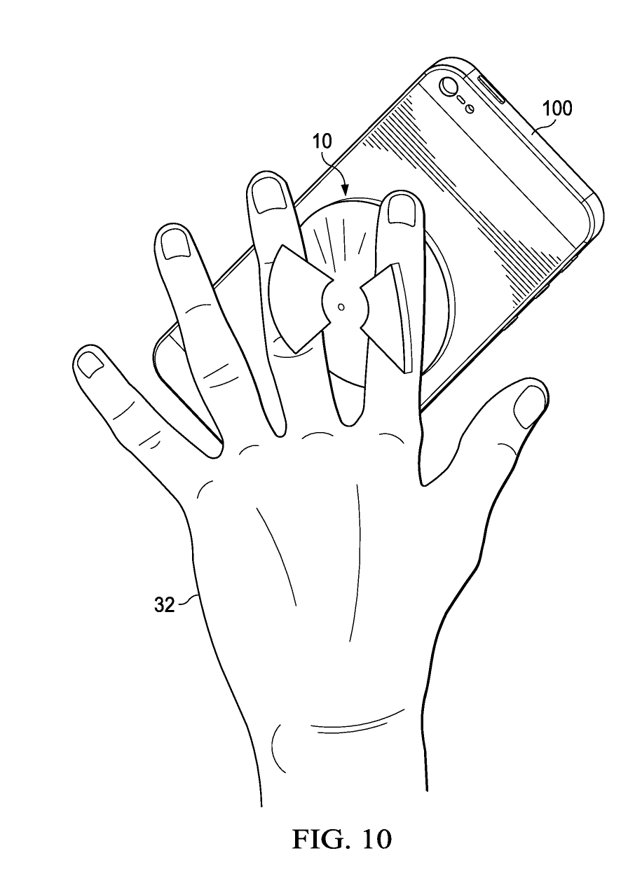

As can be understood from the description of the embodiment shown in FIGS. 7-9, in one configuration, a spinner 10 can be used both as a table-top spinning device and a finger-held spinning device. When tabs 22 are folded shut, as depicted in FIGS. 7 and 8, the spinner 10 can operate such that the smartphone can spin on apex 14 like a top on a horizontal surface. When tabs 22 are folded out, as depicted in FIG. 9, the spinner 10 can be held between the user's fingers and spun in the user's hand 32, as depicted in FIG. 10.

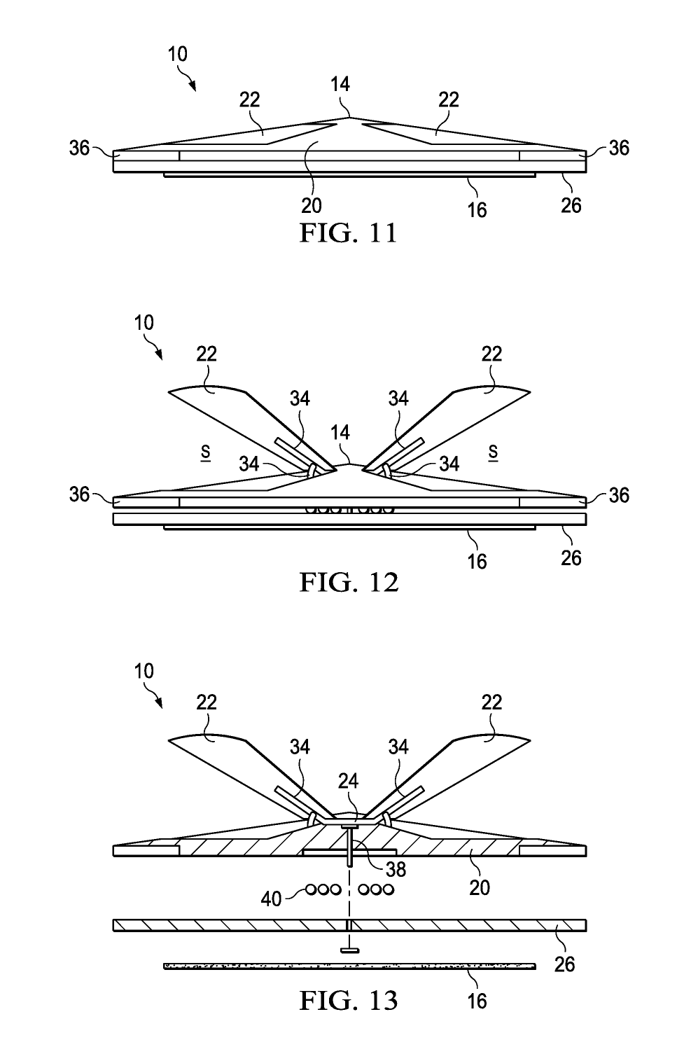

In another embodiment, as depicted schematically in FIGS. 11-13, the spinner 10 can be configured to be stationary relative to the smartphone when the tabs 22 are in an open position, and spinnably rotatable relative to the smartphone when the tabs 22 are in a closed position. A spinner in a closed configuration is shown in FIG. 11. Similarly to the description above, spinner 10 can include on the external face 20 one or more hinged tabs 22 connected to the spinner 10 by hinges 24, as depicted in FIG. 12. Hinges 24 can be living hinges and can comprise a spring 34, which can be a coil spring or a metal spring strip that remains in compressive contact with one or both tabs 22. In general, spring 34 can be a metal or plastic spring, and can comprise a strip of spring material configured in any manner as is known for urging a hinged member of a device from a closed to an open position, and likewise permits reclosing of the hinged member. In an embodiment, spring 34 can be under compression when tabs are in closed position, as shown in FIG. 11, but which compression can be at least partially released when at least one or more release mechanisms 36 are moved, such as by pressing, to release tabs 22 to be urged into an open position under the influence of spring 34. Release mechanism(s) can be a button, which can be spring-loaded and pressable to release tabs 22 which in turn can hold spring 34 in spring tension. Tabs 22 can be held flush with the surface of the external face 20 by a restraining ridge or lip of material onto which the outside edge of tabs 22 can “clip” or “click” into when pressed into a closed position, as depicted in FIG. 11. Tabs 22 can be released to spring outwardly as illustrated in FIG. 12 by pressing release mechanism 36, which can be a molded plastic button that, when urged downwardly or inwardly can release tabs 22 from their restraining ridge to “pop” out under the force of the spring 34. When urged into the outward position tabs 22 provide a space S for the fingers of a user to engage the spinner 10, as depicted in FIG. 10.

As shown in the exploded schematic view of FIG. 13, the components of spinner 10 can be secured by a pivot pin 38 having a length and clearance to permit external face 20 to rotate freely when tabs 22 are open and upper surface 20 is in a spaced apart relationship with base 26, as shown in FIG. 12. When external face 20 is in a spaced relationship with base 26, external face 20 is fee to rotate, i.e., spin, relative to base 26, which can be in a stationary, i.e., adhered, relationship to smartphone 100 via adhesive layer 16. In an embodiment, external face 20 has an internally disposed ball bearing chamber in which can be disposed a ball bearing race and a plurality of ball bearings 40 that can aid in the spinning of spinner 10 when tabs 22 are in an open position. When tabs 22 are closed, external face 20 can be in pressed contact with base 26, thereby preventing relative rotation, i.e, spinning, between external face 20 and base 26.

As can be understood from the description of FIGS. 11-13 above, spinner 10 can be configured to be a table-top spinner when tabs 22 are in a closed position, and can be configured to be a hand-held spinner when tabs are in an open position.

In an embodiment the device, such as a smartphone 100, can have memory and executable instructions to provide a visual and/or audio effect when the smartphone 100 is spun via the spinner 10. In an embodiment, a display screen can display colors, lines, shapes, or other images that provide for visual effects when the smartphone is spun on apex 14 or on a user's fingers. In an embodiment, the speakers of a smartphone can emit sounds, including music, when the smartphone is spun on apex 14, or on a user's fingers.

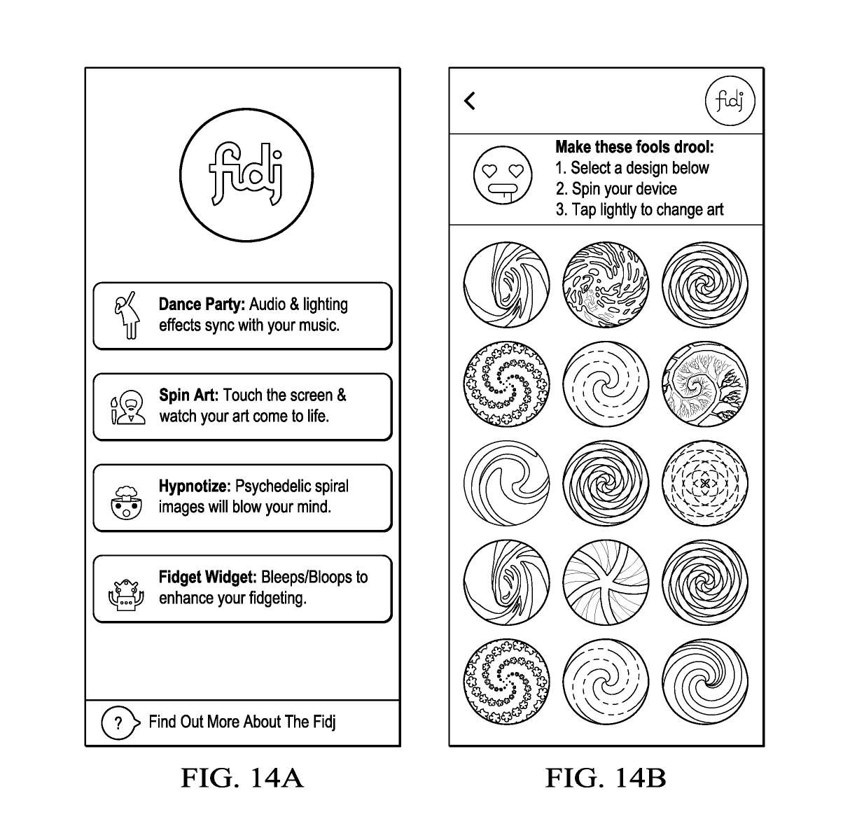

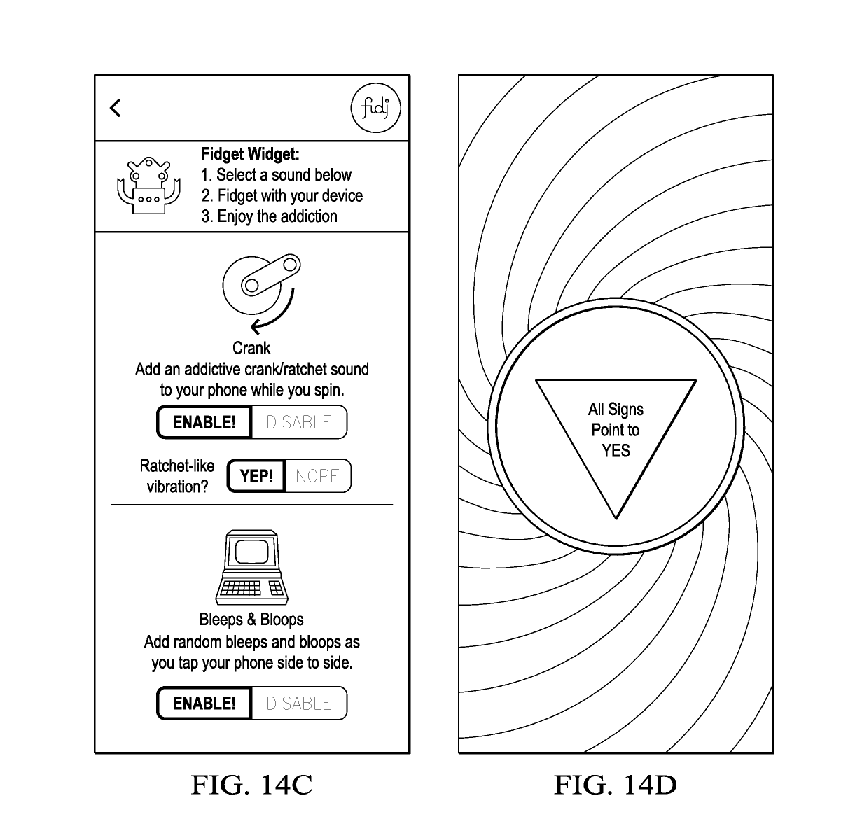

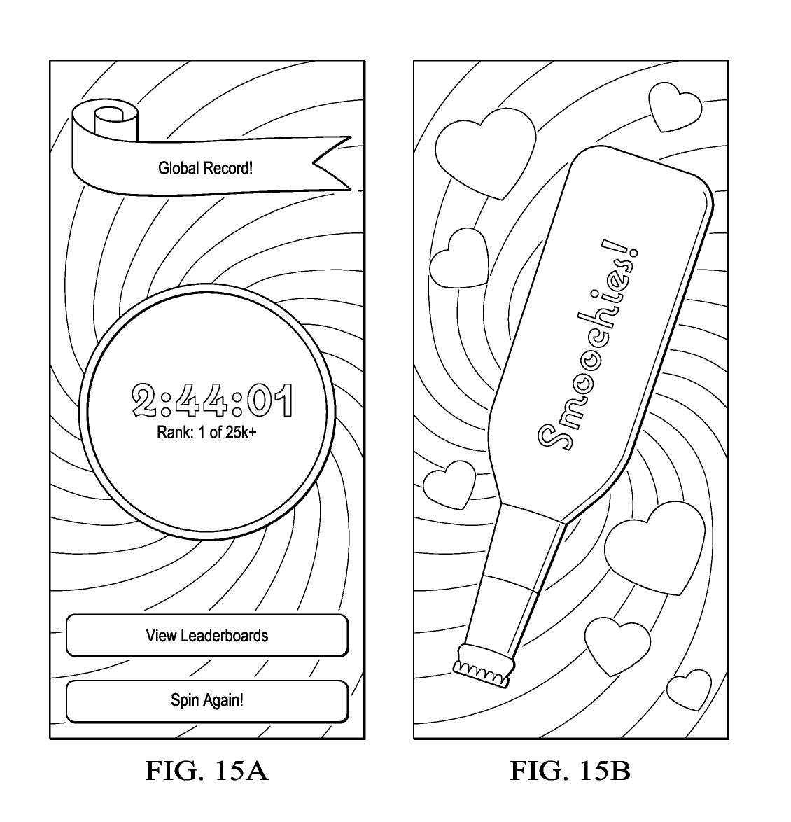

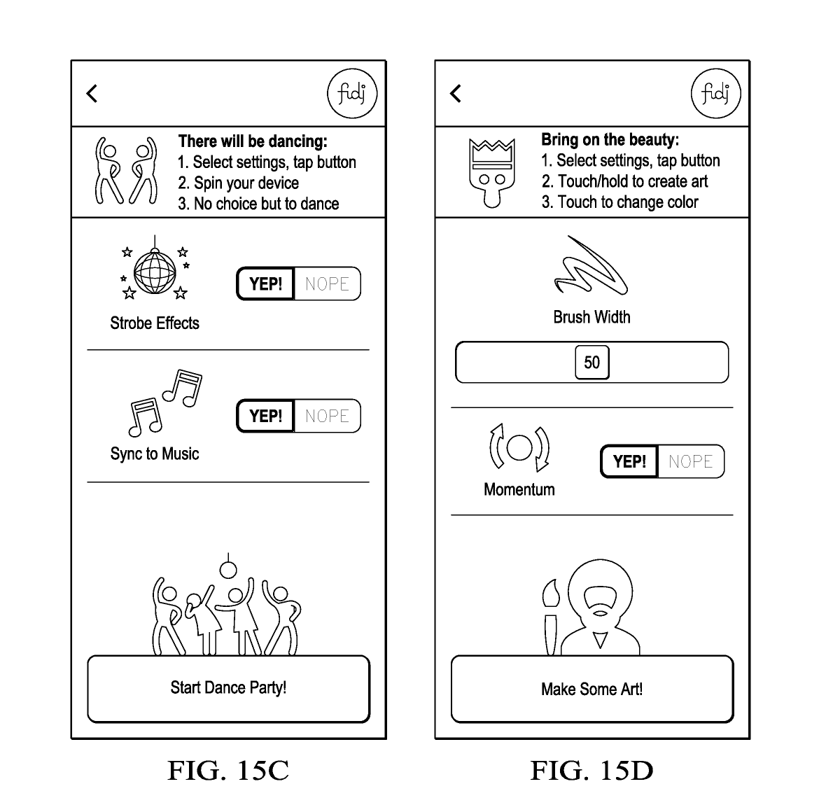

In an embodiment the device, such as a smartphone 100, can utilize one or more on-board, or web-accessed, applications that provide more functionality to the spinner 10. For example, the user can utilize apps to engage in contests, for example, to determine the longest spin time. The user can utilize apps to engage with other users of the spinner 10 to share visual effects and contest events. By way of example, FIGS. 14 A-D and FIGS. 15 A-D depict non-limiting examples of smartphone screenshots of various potential smartphone apps that can be utilized to increase the functional benefits of spinner 10.

FIG. 14A shows a screenshot of a smartphone app configured to provide a menu of various options by which the smartphone can be utilized to increase the functional benefits of spinner 10.

FIG. 14B shows an app interface screenshot in which a user can be prompted to make various aesthetically pleasing designs while utilizing the spinner 10.

FIG. 14C shows an app interface screenshot in which a user can be prompted to make various audible sounds while utilizing the spinner 10.

FIG. 14D shows an app interface that mimics the popular “Ask the 8-Ball” decision making toy. Users can spin the spinner 10, which can serve as the ball, and provide an instruction when the spinner stops spinning.

FIG. 15A shows an app interface that shows a time of spinning for a spinner. The time can be a local or global maximum time, and can be linked to game that permits a plurality of users to compare and compete with spinning times.

FIG. 15B shows an app interface that mimics the popular “Spin the Bottle” game. Users can spin their smartphone on the spinner 10, which serves as the bottle in the game.

FIG. 15C shows an app interface that provides a variety of lighting effects, such as strobe effects or music synced visual effects when the spinner 10 is utilized on a smartphone.

FIG. 15D shows an app interface that permits a user to create visual effects, including art, by utilizing the spinner 10 with a smartphone.

For all of the smartphone apps for which a spinner 10 can be utilized it is recognized that all known app-writing, testing, and implementation measures as is known in the art can be utilized. Thus, an app as described herein, is intended to cover the application, the screen displays, the software, the web links, and any and all other of known app-implementation measures as is known to those of skill in the art.

The smartphone 100 having a spinner 10 attached thereto can also be synchronized with smart home devices via wireless technologies developed for smart home devices. For example, a smartphone 100 can have memory and executable instructions to provide a visual and/or audio effect to smart home devices when the smartphone 100 is spun via the spinner 10. In an embodiment, home lighting, such as Hue Lighting by Philips can be interactively synchronized with a smartphone 100 such that the Hue Lighting can be controlled by the smartphone 100 as it spins on spinner 10. In an embodiment, swirling color patterns on the screen of the smartphone 100 can be synchronized with real-time color patterns of room lighting, such as Hue Lighting. In like manner, other home devices, such as audio devices, e.g., speakers, can be synchronized with smartphone 100.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A spinnable handheld device, the device comprising:
a. a handheld device, the handheld device having a flat surface and a center of gravity;
b. a spinner, the spinner having a base joined to the flat surface of the handheld device and an external surface extending away from the handheld device, the external surface having an apex; and
c. wherein the apex is disposed at a distance perpendicular to the flat surface near the center of gravity.

2. The spinnable handheld device of claim 1, wherein the external surface is conical shaped.

3. The spinnable handheld device of claim 1, wherein the spinner has a generally circular shape.

4. The spinnable handheld device of claim 1, wherein the base is joined to the flat surface by an adhesive.

5. The spinnable handheld device of claim 1, wherein the base is joined to the flat surface by a gel adhesive.

6. The spinnable handheld device of claim 1, wherein the handheld device has a display screen and executable instructions to execute a plurality of applications utilizing the spinner on the display screen.

7. A spinnable handheld device, the device comprising:
a. a handheld device, the handheld device having a flat surface and a center of gravity;
b. a spinner, the spinner having a base joined to the flat surface of the handheld device and an external surface extending away from the handheld device, the external surface having an apex disposed at a distance perpendicular to the flat surface near the center of gravity; and
c. at least two tabs each hingedly joined to the external surface and openable from a closed position in which the tabs are substantially flush with the external face to an open position in which the tabs define a space for a user's fingers to engage the spinner.

8. The spinnable handheld device of claim 7, wherein the external surface is conical shaped.

9. The spinnable handheld device of claim 7, wherein the spinner has a generally circular shape.

10. The spinnable handheld device of claim 7, wherein the base is joined to the flat surface by an adhesive.

11. The spinnable handheld device of claim 7, wherein the base is joined to the flat surface by a gel adhesive.

12. The spinnable handheld device of claim 7, wherein the handheld device has a display screen and executable instructions to execute a plurality of applications utilizing the spinner.

13. A spinner, the spinner comprising:
a. a base member joined by a pivot pin to an external surface portion having an apex, the external surface portion being conical shaped and being displaceable on the pivot pin from a first position in which the external surface portion is in contact with the base member and a second position in which the external surface portion is rotatable relative to the base member; and
b. at least two tabs each hingedly joined to the external surface portion and openable from a closed position in which they are substantially flush with an external face of the external surface portion to an open position in which they define an open space between the external surface portion and the base member.

14. The spinner of claim 13, further comprising a spring strip in compressive contact with one of the tabs.

15. The spinner of claim 13, wherein the base member further comprises at least one release mechanism operatively connected with at least one of the tabs.

16. The spinner of claim 13, wherein the external surface portion comprises a ball bearing race on an internal surface thereof.

17. The spinner of claim 13, wherein the external surface portion comprises a ball bearing race in which is disposed a plurality of ball bearings.

18. The spinner of claim 13, wherein the base member comprises and adhesive layer.

19. The spinner of claim 13, wherein the base member comprises a gel-based adhesive.

20. The spinner of claim 13, wherein the external surface portion and base each comprise injection molded plastic.
